(19) United States
(12) Patent Application Publication
(10) Pub. No.: US 2018/0172591 A1
(43) Pub. Date: Jun. 21, 2018

(54) OPTICAL BIOSENSOR

(71) Applicants: Jong Hyob JUN, Suwon (KR); Seung Ik JUN, San Jose, CA (US)

(72) Inventors: Jong Hyob JUN, Suwon (KR); Seung Ik JUN, San Jose, CA (US)

(21) Appl. No.: 15/844,406

(22) Filed: Dec. 15, 2017

(30) Foreign Application Priority Data
Dec. 20, 2016 (KR) 10-2016-0174395

(51) Int. Cl. G01N 21/64

(52) U.S. Cl. CPC G01N 21/6428; G01N 2021/6439

(57) ABSTRACT

Disclosed herein is an optical biosensor. The optical biosensor includes: a substrate; a photo-sensor disposed on the substrate and generating an electrical signal upon irradiation with light; and a bio-sample layer disposed on the photo-sensor and containing a target substance to be assayed and an induction material emitting light through fluorescence, extinction or luminescence upon irradiation with light, wherein the photo-sensor is irradiated with light emitted from the induction material through fluorescence, extinction or luminescence. The optical sensor detects a spectrum of a bio-sample changed by light through the photo-sensor upon irradiation with light and converts the changed spectrum into an electrical signal, thereby enabling assay of the bio-sample without using a separate detector.

### PRIORITY CLAIMS AND CROSS-REFERENCE TO RELATED APPLICATION

This patent document claims priority to and the benefit of Korean Patent Application No. 10-2016-0174395, filed on Dec. 20, 2016, which is incorporated by reference for all purposes as if fully set forth herein.

### TECHNICAL FIELD

Exemplary embodiments of the present disclosure relate to an optical biosensor, and more particularly, to an optical biosensor that can detect a bio-sample using a photo-sensor unit.

### BACKGROUND

An assay of clinically important bio-samples is an important issue in diagnosis and healthcare. Particularly, bio-samples such as DNA, RNA, proteins, enzymes, cells, hormones, and the like require an optical assay. To this end, an assay of such bio-samples is performed using an optical biosensor system based on fluorescence, extinction or luminescence.

Such a conventional optical biosensor system includes a light source, such as a laser or a light emitting device (LED), a detector, such as a photon counting detector, PMT or a CCD camera, an excitation filter, an emission filter, and a mirror, and thus has a large volume.

In assay of a bio-sample using the conventional optical biosensor system, the bio-sample is placed on a plate and is irradiated with light emitted from the light source disposed outside the system, and the detector detects light reflected by the mirror disposed at a side of the bio-sample. In this system, the excitation filter is disposed at a side of the light source and the emission filter is disposed at a side of the detector.

Since such a conventional optical biosensor system has a complicated structure and requires high assay costs, additional training for use of the optical biosensor system, and high operation costs.

Moreover, the conventional optical biosensor system is not suitable for use in point of care testing (POCT) due to the large volume thereof and it is very difficult to reduce the size of the conventional optical biosensor system.

Moreover, since the conventional optical biosensor system assays bio-samples based on images sent from the detector, the system provides a significant error in assay of the bio-sample and does not ensure an accurate assay at a site other than laboratories due to vulnerability to heat or moisture.

One example of the background technique is disclosed in Korean Patent Laid-open Publication No. 10-2013-0109470 (2013.10.08).

### SUMMARY

Exemplary embodiments of the present disclosure provide an optical biosensor that can be directly used at a site other than laboratories and requires small assay and operation costs.

In accordance with one aspect of the present disclosure, an optical biosensor includes: a substrate; a photo-sensor disposed on the substrate and generating an electrical signal upon irradiation with light; and a bio-sample layer disposed on the photo-sensor and containing a target substance to be assayed and an induction material emitting light through fluorescence, extinction or luminescence upon irradiation with light, wherein the photo-sensor is irradiated with light emitted from the induction material through fluorescence, extinction or luminescence.

The optical biosensor may further include a light source irradiates light to the photo-sensor; and a wavelength filter interposed between the photo-sensor and the bio-sample layer and blocking a fraction of light emitted from the bio-sample layer and the light source to the photo-sensor.

The wavelength filter may be detached from or coupled between the photo-sensor and the bio-sample layer depending upon an irradiation location of the photo-sensor with light.

The photo-sensor may include a plurality of sub-cells; the wavelength filter may include at least one of a short wavelength filter blocking light in a relatively short wavelength band, a middle wavelength filter blocking light in a relatively medium wavelength band, and a long wavelength filter blocking light in a relatively long wavelength band, and at least one of the short wavelength filter, the medium wavelength filter and the long wavelength filter may be provided to each of the sub-cells.

The wavelength filter may be formed of a thin film or a thick film comprising at least one of indium (In), tin (Sn), gallium (Ga), zinc (Zn) and oxygen (O).

The optical biosensor may further include a light source irradiates light to the photo-sensor; and a wavelength filter blocking a fraction of light emitted from the bio-sample layer and the light source to the photo-sensor. Here, the wavelength filter may be disposed on the photo-sensor unit or the bio-sample layer.

The bio-sample layer may be disposed on a portion of the photo-sensor to form an assay sensing area and a remaining portion of the photo-sensor with no bio-sample layer disposed thereon may form a reference sensing area.

The photo-sensor may further include a photodiode generating an electrical signal upon irradiation with light; and a first thin film transistor processing the electrical signal generated by the photodiode, and may further include a second thin film transistor removing a remaining current component accumulated in the photodiode and the first thin film transistor.

The optical biosensor may further include a gate line, a gate reset line and a data line, and each of the first and second thin film transistors may be disposed in a region in which the gate line, the gate reset line and the data line are formed.

The first thin film transistor may include a gate, a source and a drain, in which the drain of the first thin film transistor may be connected to the data line and the gate of the first thin film transistor may be connected to the gate line.

The second thin film transistor may include a gate, a source and a drain, in which the gate of the second thin film transistor may be connected to the gate reset line.

The optical biosensor may further include a third thin film transistor amplifying an output from the photodiode, and may further include a gate line, a gate reset line and a data line, in which the third thin film transistor may be disposed in a region in which the gate line, the gate reset line and the data line are formed.

The photo-sensor may include a complementary metal oxide semiconductor (CMOS) in which a photodiode generating an electrical signal upon irradiation with light and a MOSFET are combined.

Exemplary embodiments of the present disclosure provide an optical biosensor that detects a spectrum of a bio-sample changed by light using a photo-sensor unit and converts the changed spectrum into an electrical signal, thereby enabling assay of the bio-sample without using a separate detector. As a result, the optical bio-sensor can perform immediate assay of the bio-sample at a site other than laboratories.

### BRIEF DESCRIPTION OF DRAWINGS

The accompanying drawings, which are included to provide a further understanding of the disclosed technology, and are incorporated in and constitute a part of this specification, illustrate exemplary embodiments of the disclosed technology, and together with the description serve to describe the principles of the disclosed technology.

FIG. 1 is a plan view of an optical biosensor according to one exemplary embodiment of the present disclosure.

FIG. 2 is a cross-sectional view taken along line A-A′ of FIG. 1.

FIG. 3A and FIG. 3B are sectional views illustrating an operation of assaying a bio-sample using the optical biosensor according to the exemplary embodiment of the present disclosure.

FIG. 4 is a plan view of an optical biosensor according to another exemplary embodiment of the present disclosure.

FIG. 5 is a cross-sectional view taken along line B-B′ of FIG. 4.

FIG. 6 is a plan view of an optical biosensor according to a further exemplary embodiment of the present disclosure.

FIG. 7A and FIG. 7B are plan views of examples of sub-cells of the optical biosensor according to the exemplary embodiments of the present disclosure.

FIG. 8A to FIG. 8C are a circuit diagram, a cross-sectional view and a plan view of one example of a photo-sensor unit of the optical biosensor according to the exemplary embodiments of the present disclosure, to which one thin film transistor is applied.

FIG. 9A to FIG. 9C are a circuit diagram, a cross-sectional view and a plan view of another example of the photo-sensor unit of the optical biosensor according to the exemplary embodiments of the present disclosure, to which two thin film transistors are applied.

FIG. 10A and FIG. 10B are a circuit diagram and a plan view of a further example of the photo-sensor unit of the optical biosensor according to the exemplary embodiments of the present disclosure, to which three thin film transistors are applied.

FIG. 11A and FIG. 11B are graphs depicting quantum efficiency and output signals of a photodiode of the optical biosensor according to the exemplary embodiments of the present disclosure.

FIG. 12A and FIG. 12B are a graph depicting increase in fluorescence intensity through reaction of a fluorescence induction material contained in a fluorescent bio-sample layer of the optical biosensor according to the exemplary embodiments of the present disclosure and a graph depicting electrical signal output.

FIG. 13A to FIG. 13E are graphs depicting a function of a wavelength filter of the optical biosensor according to the exemplary embodiments of the present disclosure.

FIG. 14 shows the optical biosensor according to the exemplary embodiments of the present disclosure and an analyzer.

FIG. 15 shows the optical biosensor according to the exemplary embodiments of the present disclosure and a modification of the analyzer.

### DETAILED DESCRIPTION

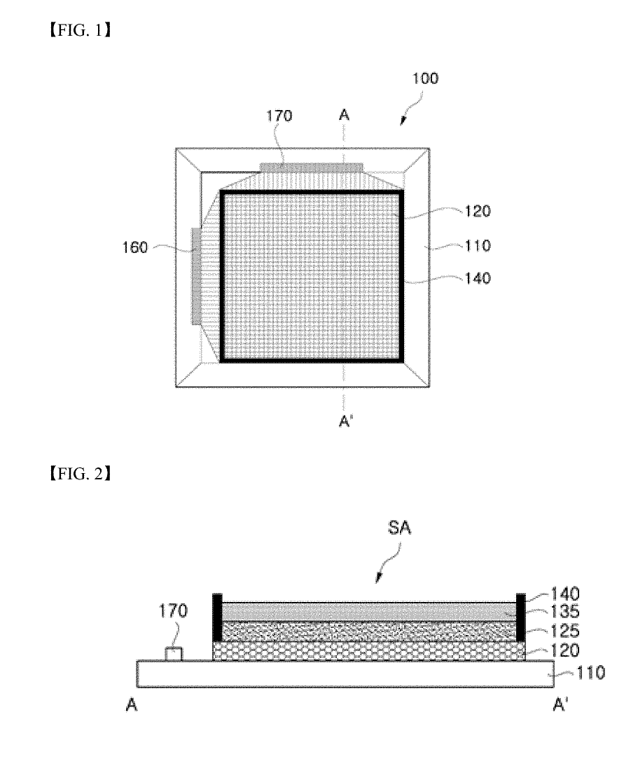

Hereinafter, exemplary embodiments of the present disclosure will be described in detail with reference to the accompanying drawings. FIG. 1 is a plan view of an optical biosensor according to one exemplary embodiment of the present disclosure and FIG. 2 is a cross-sectional view taken along line A-A′ of FIG. 1.

Referring to FIG. 1 and FIG. 2, an optical biosensor 100 according to one exemplary embodiment includes a mount 110, a photo-sensor unit 120, a wavelength filter 125, a fluorescent bio-sample layer 135, a wall 140, a read-out pad 160, and a gate driving pad 170.

The mount 110 supports the photo-sensor unit 120, the wavelength filter 125, the fluorescent bio-sample layer 135, the wall 140, the read-out pad 160, and the gate driving pad 170. The mount 110 serves to couple the optical biosensor 100 to an analyzer described below, in which the fluorescent bio-sample layer 135 includes a fluorescence induction substance and a bio-sample.

The photo-sensor unit 120 has sub-cells 122 or pixels as basic elements and may include a plurality of sub-cells 122 regularly arranged thereon. The photo-sensor unit 120 serves to convert the spectrum of light into an electrical signal after analysis of the light detected thereby. The photo-sensor unit 120 may include a photodiode 37 and at least one thin film transistor, which will described in detail below. The photo-sensor unit 120 may be disposed on the mount 110.

The photo-sensor unit 120 may include a MOSFET instead of the at least one thin film transistor. Alternatively, the photo-sensor unit 120 may include a complementary metal oxide semiconductor (CMOS) in which the MOSFET and the photodiode 37 are combined.

The wavelength filter 125 may be disposed on the photo-sensor unit 120. The wavelength filter 125 includes a short wavelength filter and a long wavelength filter. The short wavelength filter serves to block light in a low wavelength band of the visible range and the long wavelength filter serves to block in a high wavelength band of the visible range.

The wavelength filter 125 may be formed of at least one of indium (In), tin (Sn), gallium (Ga), zinc (Zn), and oxygen (O), and may be a thin film filter or a thick film filter.

The fluorescent bio-sample layer 135 may be disposed on the wavelength filter 125 and generates light through fluorescence, extinction or luminescence when receiving light in a particular wavelength band or plural wavelength bands from a light source. The fluorescent bio-sample layer 135 may be at least one of a membrane, an absorbent pad, and a conjugate pad. In addition, the fluorescent bio-sample layer 135 may contain a target substance to be assayed, such as DNA, RNA, proteins, enzymes, cells, and hormones, in a state of being mixed with a fluorescence, extinction or luminescence induction material.

In this exemplary embodiment, the wavelength filter 125 is disposed on the photo-sensor unit 120 and the fluorescent bio-sample layer 135 is disposed on the wavelength filter 125. However, it should be understood that other implementations are possible. Alternatively, the wavelength filter 125 may be formed on the fluorescent bio-sample layer 135 formed on the photo-sensor unit 120, as needed.

The wall 140 may be disposed on the photo-sensor unit 120 such that a predetermined area is defined inside an edge of the photo-sensor unit 120. With this structure, the wavelength filter 125 and the fluorescent bio-sample layer 135 are disposed inside the wall 140 and are not moved outside the wall 140. Here, the interior area of the wall 140 is defined as an assay sensing area (SA).

Each of the read-out pad 160 and the gate driving pad 170 may be disposed on the mount 110 to be placed outside the wall 140. The read-out pad 160 and the gate driving pad 170 may be disposed on different surfaces of the mount 110 and may be electrically connected to the photo-sensor unit 120. Each of the read-out pad 160 and the gate driving pad 170 may be electrically connected to the sub-cells 122 of the photo-sensor unit 120 to supply electric power to each of the sub-cells 122 and to output an electrical signal corresponding to data analyzed by each of the sub-cells 122.

Such an optical biosensor 100 may be used once or plural times depending upon an environment and costs.

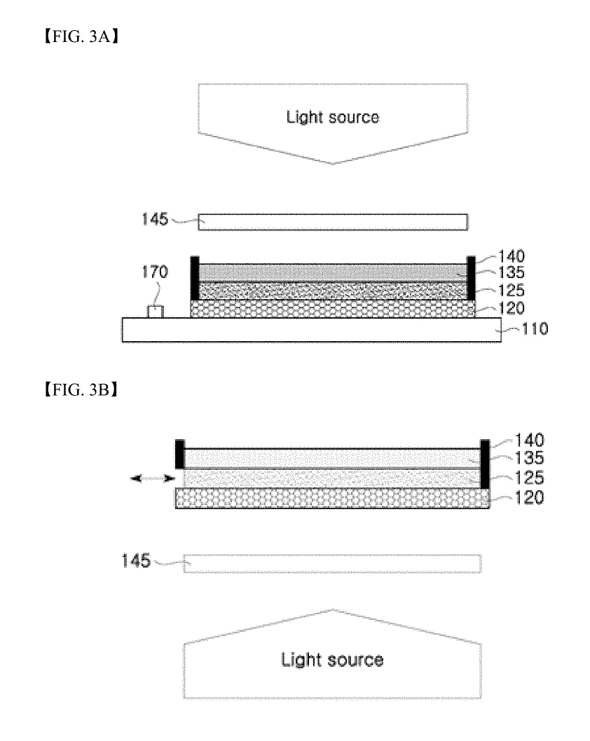

FIG. 3A and FIG. 3B are sectional views illustrating an operation of assaying a bio-sample using the optical biosensor according to the exemplary embodiment of the present disclosure.

First, FIG. 3A shows one example of the assay operation, in which a light source is disposed above the mount 110. In this example, the light source is disposed above the fluorescent bio-sample layer 135. Here, an excitation filter 145 may be disposed between the light source and the fluorescent bio-sample layer 135.

The light source may be a laser or a light emitting diode (LED). Specifically, the light source may include at least one of a red LED, a green LED and a blue LED in order to emit light in a broad wavelength band.

Referring to FIG. 3A, in the structure wherein the light source is disposed above the optical biosensor 100, when the light source emits light towards the fluorescent bio-sample layer 135, the fluorescent bio-sample layer 135 generates light through fluorescence, extinction or luminescence by light having a particular wavelength or wavelengths, and the light generated through fluorescence, extinction or luminescence is detected by the photo-sensor unit 120. In the photo-sensor unit 120, a difference in current or voltage generated by a photoelectric effect may be converted into an electrical signal by the thin film transistor or the MOSFET and output through the read-out pad 160.

In this way, since the photo-sensor unit 120 generates an electrical signal through direct conversion of the light emitted from the fluorescent bio-sample layer 135 and is not affected by heat or moisture, the photo-sensor unit 120 has high accuracy and can be used at any site regardless of assay location. Furthermore, the photo-sensor unit has a simple structure enabling reduction in weight and size thereof and thus can be used as POCT equipment.

FIG. 3B shows another example of the assay operation, in which the light source is disposed below the mount 110. In this example, the excitation filter 145 may be disposed between the light source and the photo-sensor unit 120.

In addition, the wavelength filter 125 disposed between the fluorescent bio-sample layer 135 and the photo-sensor unit 120 may be removed or replaced. Specifically, the wavelength filter 125 may be removed therefrom in order to allow the fluorescent bio-sample layer 135 to be excited by light emitted from the light source disposed below the fluorescent bio-sample layer 135. In addition, the wavelength filter 125 may be disposed between the fluorescent bio-sample layer 135 and the photo-sensor unit 120 in order to filter light emitted from the fluorescent bio-sample layer 135 and the light source through fluorescence, extinction or luminescence into light in a predetermined wavelength band. To this end, no separate wall may be disposed at a side of the wavelength filter 125, as shown in FIG. 3B.

Further, in order to allow light emitted from the light source disposed below the fluorescent bio-sample layer 135 to reach the fluorescent bio-sample layer 135, the photo-sensor unit 120 may include a transparent substrate and the mount 110 may be transparent.

As such, in the structure wherein the light source is disposed below the optical biosensor 100, the photo-sensor unit 120 can block heat generated from the light source or other components, thereby preventing a target substance inside the fluorescent bio-sample layer 135 from being contaminated or degraded by heat.

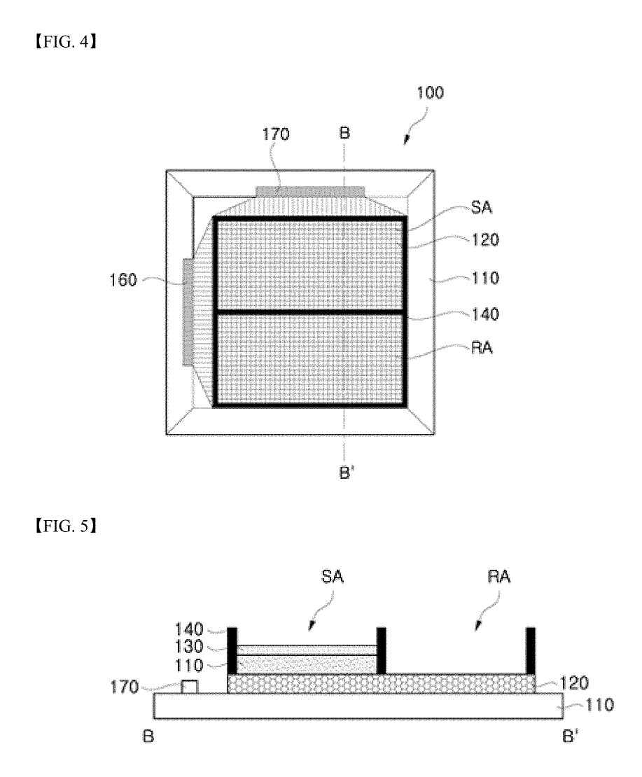

FIG. 4 is a plan view of an optical biosensor according to another exemplary embodiment of the present disclosure and FIG. 5 is a cross-sectional view taken along line B-B′ of FIG. 4.

An optical biosensor 100 according to another exemplary embodiment will be described with reference to FIG. 4 and FIG. 5. The optical biosensor 100 according to this exemplary embodiment is substantially similar to the optical biosensor according to the above exemplary embodiment and further includes a reference sensing area RA in addition to the assay sensing area SA. The reference sensing area RA serves to obtain a reference value with respect to an assay result provided by the assay sensing area SA and to correct an experimental value obtained in the assay sensing area SA.

Thus, as shown in FIG. 4, the assay sensing area SA may be a region on the photo-sensor unit 120 and the reference sensing area RA may be the remaining region on the photo-sensor unit 120. Here, the assay sensing area SA may be disposed at a side of the gate driving pad 170.

Referring to FIG. 5, the assay sensing area SA of the optical biosensor 100 according to this exemplary embodiment has the same structure as that of the optical biosensor 100 according to the above exemplary embodiment. Further, in the reference sensing area RA, only the photo-sensor unit 120 is disposed on the mount 110, and the wavelength filter 125 and the fluorescent bio-sample layer 135 are not disposed on the photo-sensor unit 120. With this structure, the reference sensing area RA can measure a reference value of a photoelectric effect under conditions of no fluorescence, extinction or luminescence by light emitted from the light source.

In this exemplary embodiment, the light source may be disposed above or below the optical biosensor 100, as shown in FIG. 3A and FIG. 3B.

FIG. 6 is a plan view of an optical biosensor according to a further exemplary embodiment of the present disclosure.

An optical biosensor 100 according to a further exemplary embodiment will be described with reference to FIG. 6. The optical biosensor 100 according to this exemplary embodiment is substantially similar to the optical biosensor according to the above exemplary embodiment. In this exemplary embodiment, one of plural sub-cells 122 disposed on the photo-sensor unit 120 may be defined as a reference sensing area RA. Obviously, the reference sensing area RA can be defined by a number of sub-cells 122 instead of one sub-cell 122. Here, the sub-cell 122 defined as the reference sensing area RA may be placed at any location, for example, at the center or an edge of the photo-sensor unit 120.

On the photo-sensor unit 120, the assay sensing area SA according to this exemplary embodiment has the same structure as that of the optical biosensor 100 according to the above exemplary embodiment, and the reference sensing area RA according to this exemplary embodiment may be the same as the reference sensing area RA according to the other exemplary embodiment. Thus, detailed description thereof will be omitted.

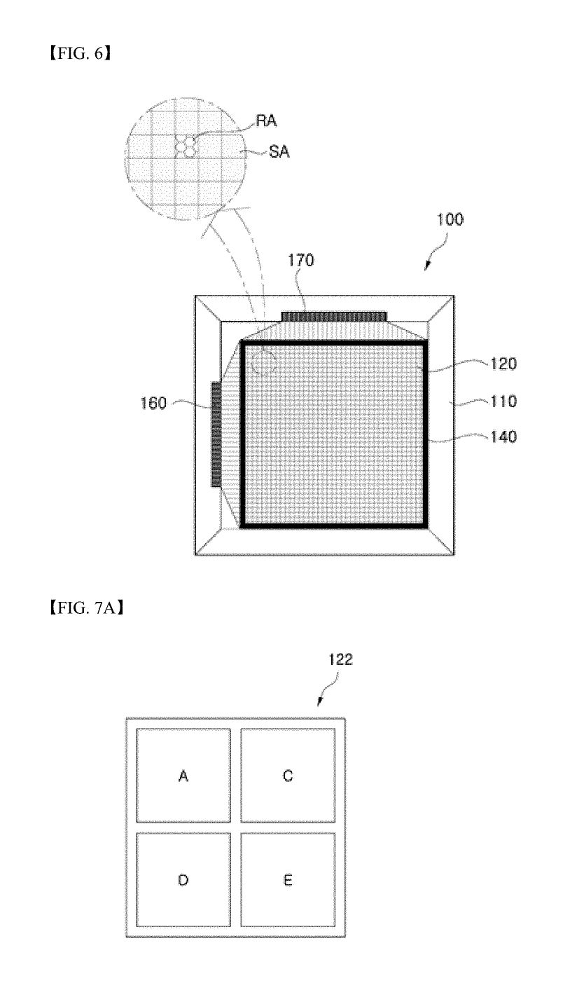

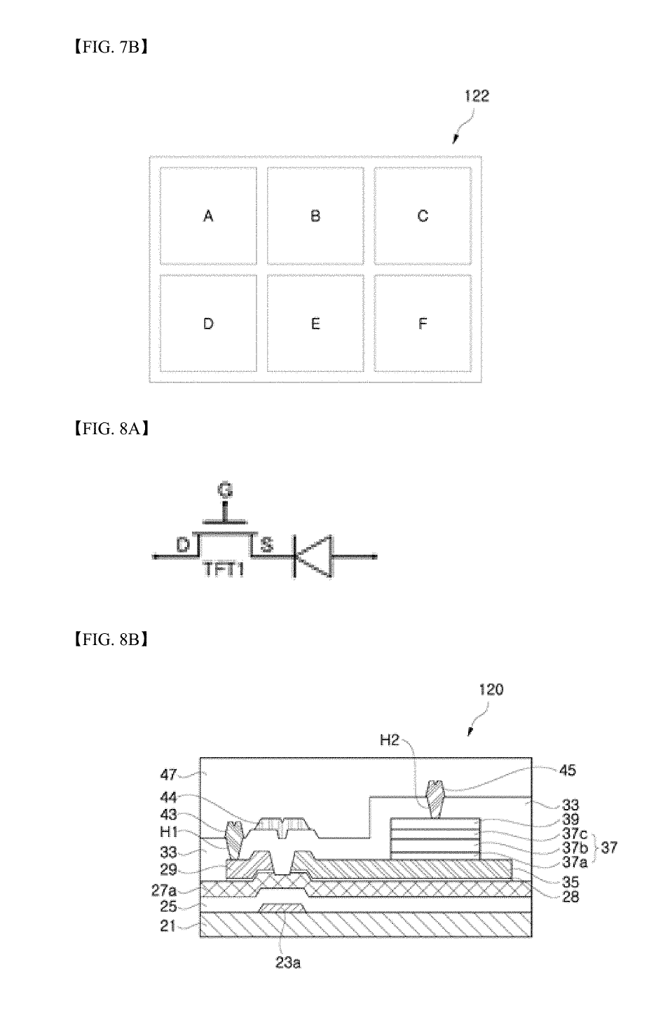

FIG. 7A and FIG. 7B are plan views of examples of sub-cells of the optical biosensor according to the exemplary embodiments of the present disclosure.

FIG. 7A and FIG. 7B show part of unit sub-cells 122 constituting the optical biosensor 100 depending on the presence of the wavelength filter 125 and the fluorescent bio-sample layer 135 and emission of light towards the photo-sensor unit 120.

In FIG. 7A, four sub-cell regions (Regions A, C, D and E) are defined as one unit, and in FIG. 7B, six sub-cell regions (Regions A, B, C, D, E and F) are defined as one unit.

Here, a wavelength filter 125 in Region A of the sub-cell 122 is a short wavelength filter configured to block light in a short wavelength band, a wavelength filter 125 in Region B of the sub-cell 122 is a medium wavelength filter configured to block light in a medium wavelength band, and a wavelength filter 125 in Region C of the sub-cell 122 is a long wavelength filter configured to block light in a long wavelength band. Here, it should be noted that the short wavelength band, the medium wavelength band, and the long wavelength band are relatively defined and a wavelength band to be blocked can be changed as needed.

Region D is a reference sensing area RA from which the fluorescent bio-sample layer 135 and the wavelength filter 125 are removed, and is set to measure photo current in a state that light does not reach the photo-sensor unit 120 therethrough. Region E is also another reference sensing area RA from which the fluorescent bio-sample layer 135 and the wavelength filter 125 are removed, and is set to measure photo current in a state that light is emitted to the photo-sensor unit 120 such that the photo-sensor unit 120 can be completely saturated with the light. In addition, Region F is a further reference sensing area RA from which the fluorescent bio-sample layer 135 and the wavelength filter 125 are removed.

Locations of Regions A, B, C, D, E and F of each of the unit cells 122 shown in FIG. 7A and FIG. 7B can be changed, and combinations of Regions A, B, C, D, E and F can also be changed as needed.

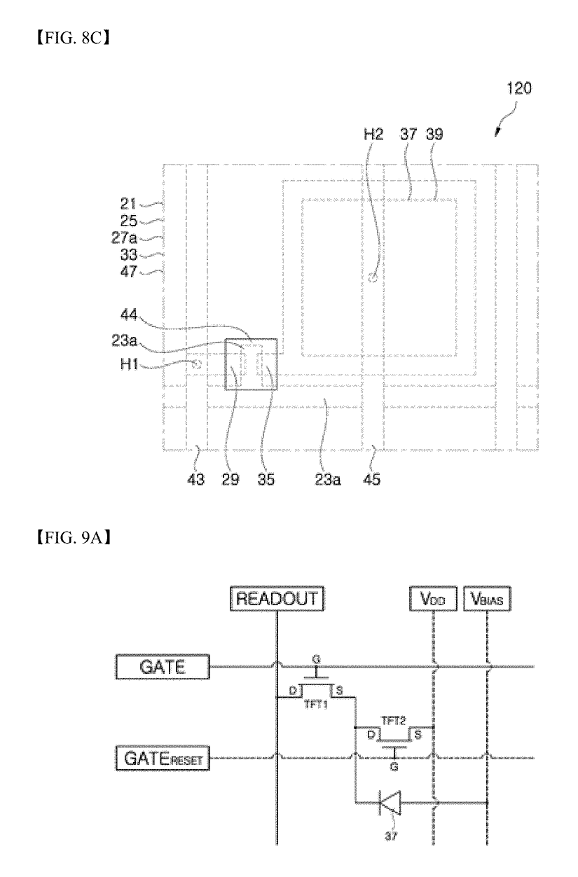

FIG. 8A to FIG. 8C are a circuit diagram, a cross-sectional view and a plan view of one example of the photo-sensor unit of the optical biosensor according to the exemplary embodiments of the present disclosure, to which one thin film transistor is applied.

Referring to FIG. 8A to FIG. 8C, the photo-sensor unit 120 corresponds to one sub-cell 122, and may include one thin film transistor and the photodiode 37, as shown in FIG. 8A.

Specifically, the photo-sensor unit 120 includes a substrate 21, a first gate 23a, a first insulation layer 25, a first semiconductor active layer 27a, an ohmic contact layer 28, a drain 29, a second insulation layer 33, a lower electrode 35, the photodiode 37, a transparent electrode 39, a data line 43, a light blocking layer 44, a bias line 45, and a protective layer 47.

Referring to FIG. 8B and FIG. 8C, the substrate 21 may be disposed at a lower side of the photo-sensor unit 120, and other components of the photo-sensor unit 120 may be stacked on the substrate 21. The first gate 23a is disposed on the substrate 21 so as to have a predetermined length across the substrate 21. The first gate 23a may have a protrusion protruding therefrom in the perpendicular direction with respect to the longitudinal direction thereof. The first gate 23a may be formed of a single metal or an alloy including at least one of Al, Al—Nd, Al—Cu, Mo, Ti, Ta and Cr, and may be composed of a single layer or multiple layers. The first gate 23a may be electrically connected to the gate driving pad 170.

The first insulation layer 25 may be disposed on the first gate 23a. The first insulation layer 25 may be disposed so as to cover the entirety of an upper surface of the substrate 21 and serve to electrically insulate other electrodes from the first gate. The first insulation layer 25 may include SiO₂ and the like.

The first semiconductor active layer 27a is disposed on the first insulation layer 25. The first semiconductor active layer 27a may be disposed only on the first gate 23a or may be disposed to cover the entirety of the upper surface of the substrate 21. The first semiconductor active layer 27a may include at least one of non-crystalline silicon, low temperature polycrystalline silicon and oxide semiconductors. The oxide semiconductor may include at least one of In, Ga and Zn oxides.

The drain 29 and the lower electrode 35 may be disposed on the first semiconductor active layer 27a. The drain 29 and the lower electrode 35 may include the same material and may be simultaneously formed by the same process. The drain 29 and the lower electrode 35 may be formed of one electrode member elongated in the longitudinal direction, and may be separated from each other on the gate by etching.

The first semiconductor active layer 27a, the first gate 23a, the drain 29 and the lower electrode 35 may constituted a single thin film transistor. Here, the lower electrode 35 may be a source 31 of the thin film transistor. Each of the drain 29 and the lower electrode 35 may be formed of a single metal or an alloy including at least one of Al, Al—Nd, Al—Cu, Mo, Ti, Ta and Cr, and may be composed of a single layer or multiple layers.

In order to enhance ohmic contact between the first semiconductor active layer 27a and a second semiconductor active layer 27b and between the drain 29 and the lower electrode 35, the ohmic contact layer 28 may be interposed therebetween. That is, the ohmic contact layer 28 may be interposed between the first semiconductor active layer 27a and the drain 29 and between the second semiconductor active layer 27b and the lower electrode 35.

The photodiode 37 may be disposed on the lower electrode 35. The photodiode 37 may be a PIN diode, an avalanche photodiode (APD), or the like, and can generate an electrical signal in response to light emitted to the photodiode 37.

The photodiode 37 may include an n-type semiconductor layer 37a, an intrinsic semiconductor layer 37b, and a p-type semiconductor layer 37c, each of which may be a non-crystalline silicon semiconductor layer, a low temperature polycrystalline silicon semiconductor layer, or an oxide semiconductor layer including at least one of gallium (Ga), indium (In), tin (Sn), and zinc (Zn). By way of example, the photodiode 37 may have a stack structure of an n+ nanocrystalline silicon layer and a p+ nanocrystalline silicon layer in order to improve characteristics of the photodiode 37 based on relatively high electron mobility and low current leakage of nanocrystalline silicon.

The transparent electrode may be disposed on the photodiode 37. The transparent electrode includes a transparent conductive material, such as indium tin oxide (ITO), indium zinc oxide (IZO), aluminum zinc oxide (AZO), and ZnO.

As described above, the photodiode 37 is disposed only on the lower electrode 35, and the second insulation layer 33 is disposed to cover the drain 29, the lower electrode 35, the first semiconductor active layer 27a exposed between the drain 29 and the lower electrode 35, the photodiode 37, and the upper electrode. The second insulation layer 33 may be transparent.

In addition, the data line 43, the light blocking layer 44 and the bias line 45 are disposed on the second insulation layer 33. The data line 43 is disposed on the drain 29 to have a predetermined length and is electrically connected to the drain 29 through a first via-hole H1. The bias line 45 is disposed on the upper electrode to have a predetermined length and is electrically connected to the upper electrode through a second via-hole H2. The light blocking layer 44 is disposed on the first gate 23a on the second insulation layer 33.

Then, the protective layer 47 is formed on the data line 43, the light blocking layer 44 and the bias line 45 to cover the data line 43, the light blocking layer 44 and the bias line 45. The protective layer 47 may be a transparent layer and may be formed of the same material as the first and second insulation layers 35, 33.

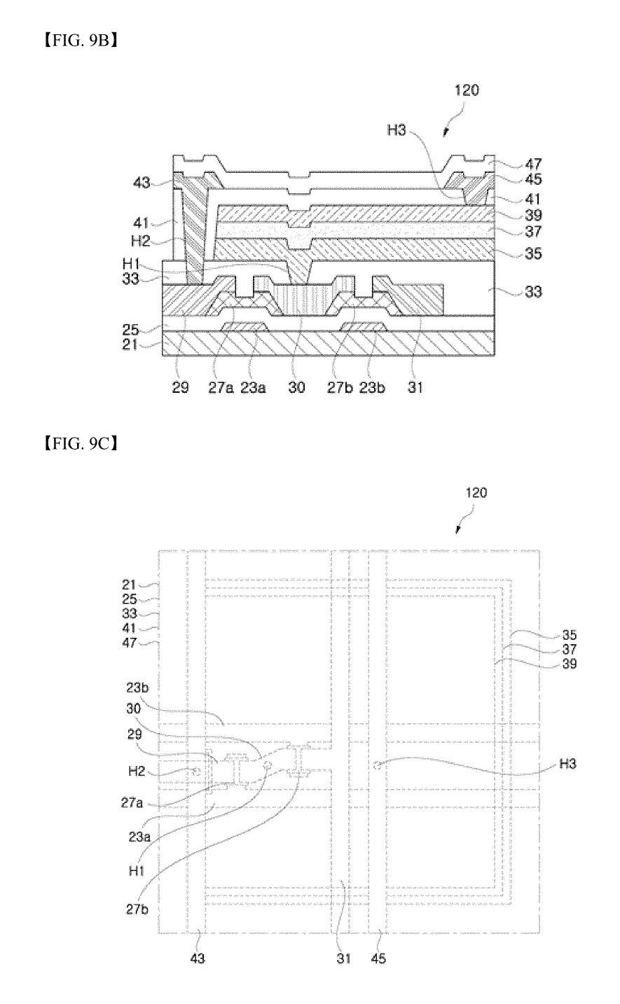

FIG. 9A to FIG. 9C are a circuit diagram, a cross-sectional view and a plan view of another example of the photo-sensor unit of the optical biosensor according to the exemplary embodiments of the present disclosure, to which two thin film transistors are applied.

Referring to FIG. 9A to FIG. 9C, the photo-sensor unit 120 corresponds to one sub-cell 122, and may include two thin film transistors and the photodiode 37, as shown in FIG. 9A.

A first thin film transistor TFT1 severs to process a signal output from the photodiode 37 excited by visible light. A second thin film transistor TFT2 serves to remove a remaining current component accumulated in the first thin film transistor TFT1 and the photodiode 37.

To this end, the first thin film transistor TFT1 processes an output from a pixel. In addition, a source of the first thin film transistor TFT1 may be connected to a drain of the second thin film transistor TFT2 and a drain of the first thin film transistor TFT1 may be connected to a read-out element through the data line 43. Further, a gate of the first thin film transistor TFT1 may be connected to a gate line.

The second thin film transistor TFT2 changes the state of each of the first thin film transistor TFT1 and the photodiode 37 to a ground state by removing the remaining current component accumulated in the first thin film transistor TFT1 and the photodiode 37, thereby improving actual sensitivity and signal to noise ratio. To this end, a source of the second thin film transistor TFT2 is connected to a VDD line and a drain of the second thin film transistor TFT2 is commonly connected to the photodiode 37 and the source of the first thin film transistor TFT1. In addition, a gate of the second thin film transistor TFT2 may be connected to a gate reset line.

As described above, the photodiode 37 may be connected at one side thereof to the drain of the second thin film transistor TFT2 and at the other side thereof to the bias line 45.

The photo-sensor unit 120 including two thin film transistors includes a substrate 21, a first gate 23a, a second gate 23b, a first insulation layer 25, a first semiconductor active layer 27a, a second semiconductor active layer 27b, a drain 29, a connection electrode, a source 31, a second insulation layer 33, a lower electrode 35, the photodiode 37, a transparent electrode 39, a third insulation layer 41, a data line 43, a bias line 45, and a protective layer 47.

Each of the first gate 23a and the second gate 23b is disposed on the substrate 21 to have a predetermined length. In addition, each of the first gate 23a and the second gate 23b may have a protrusion protruding therefrom in the perpendicular direction with respect to the longitudinal direction thereof to face another protrusion while being separated from the other protrusion.

The first insulation layer 25 may be disposed so as to cover upper surfaces of the first gate 23a and the second gate 23b, and the first gate 23a may be insulated from the second gate 23b by the first insulation layer 25.

The first semiconductor active layer 27a and the second semiconductor active layer 27b are disposed on the first insulation layer 25 to be disposed above the first gate 23a and the second gate 23b, respectively. The first semiconductor active layer 27a may be separated from the second semiconductor active layer 27b by a predetermined distance or more.

The drain 29, the connection electrode 30 and the source 31 are disposed on the first semiconductor active layer 27a and the second semiconductor active layer 27b. The drain 29, the connection electrode 30 and the source 31 may include the same material and may be electrically connected to the first semiconductor active layer 27a and the second semiconductor active layer 27b.

Specifically, the drain 29 is disposed to cover a portion of the first semiconductor active layer 27a, the connection electrode 30 is disposed to cover a portion of each of the first semiconductor active layer 27a and the second semiconductor active layer 27b, and the source 31 is disposed to cover a portion of the second semiconductor active layer 27b.

The drain 29 may be electrically connected to the read-out pad 160 through the data line 43, and the connection electrode 30 may be electrically connected to the VDD line.

The second insulation layer 33 may be disposed to cover the drain 29, the connection electrode 30 and the source 31, and may also cover the entirety of the substrate 21.

The lower electrode 35 is disposed on the second insulation layer 33. The lower electrode 35 has a sufficient width to cover the first semiconductor active layer 27a and the second semiconductor active layer 27b, and may be electrically connected to the connection electrode 30 through a first via-hole H1.

The photodiode 37 may be disposed on the lower electrode 35. The photodiode 37 may be disposed to cover the entirety of the lower electrode 35 and generate an electrical signal in response to light emitted to the photodiode 37. Details of the photodiode 37 are the same as those described with reference to FIG. 8A to FIG. 8C, and detailed description thereof will be omitted.

The transparent electrode 39 may be disposed on the photodiode 37. The transparent electrode 39 may be disposed to cover the entirety of the photodiode 37 and may have a smaller size than the photodiode 37.

In addition, the third insulation layer 41 is disposed to cover exposed regions of the second insulation layer 33 and the transparent electrode 39, which are not covered by the lower electrode 35. The third insulation layer 41 may be formed of the same material as the first and second insulation layers 25, 33.

The data line 43 and the bias line 45 may be disposed on the third insulation layer 41. The data line 43 may be electrically connected to the drain 29 through a second via-hole H2 formed in the second insulation layer 33 and the third insulation layer 41. The bias line 45 may be electrically connected to the transparent electrode 39 through a third via-hole H3 formed in the third insulation layer 41.

The protective layer 47 may be disposed on the data line 43 and the bias line 45 to cover the data line 43 and the bias line 45.

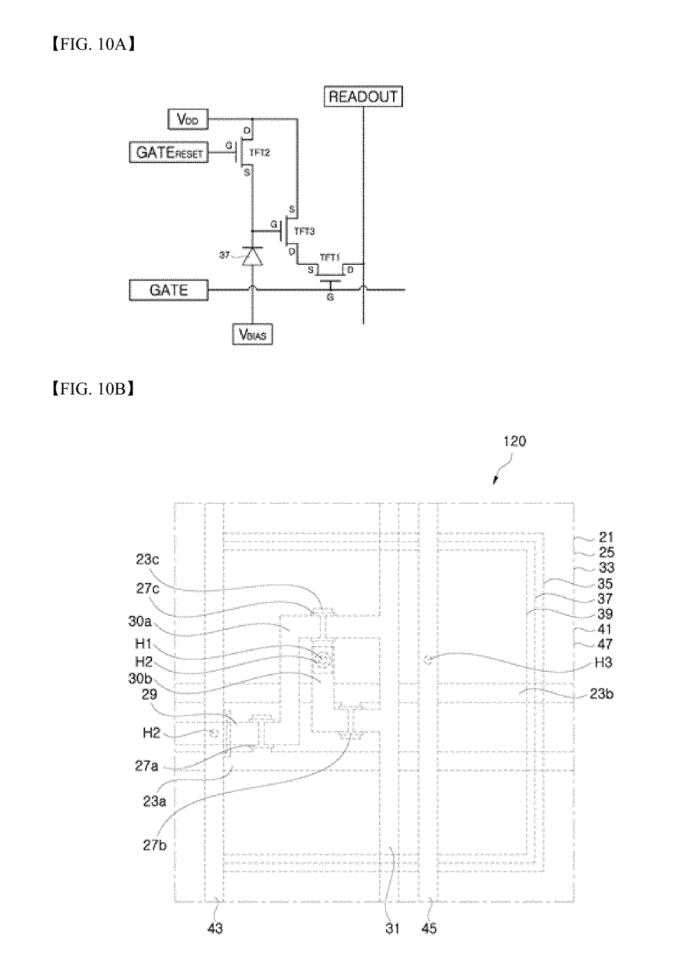

FIG. 10A and FIG. 10B are a circuit diagram and a plan view of a further example of the photo-sensor unit of the optical biosensor according to the exemplary embodiments of the present disclosure, to which three thin film transistors are applied.

Referring to FIG. 10A and FIG. 10B, the photo-sensor unit 120 corresponds to one sub-cell 122, and may include three thin film transistors and the photodiode 37, as shown in FIG. 10A.

A first thin film transistor TFT1 severs to process a signal output from the photodiode 37 excited by visible light. A second thin film transistor TFT2 serves to remove a remaining current component accumulated in the first thin film transistor TFT1 and the photodiode 37, and a third thin film transistor TFT3 serves to amplify a brightness signal output from the photodiode 37.

To this end, the first thin film transistor TFT1 processes an output from a pixel. In addition, a source of the first thin film transistor TFT1 may be connected to a drain of the third thin film transistor TFT3 and a drain of the first thin film transistor TFT1 may be connected to a read-out element through the data line 43. Further, a gate of the first thin film transistor TFT1 may be connected to a gate line.

The second thin film transistor TFT2 changes the state of each of the first thin film transistor TFT1 and the photodiode 37 to a ground state by removing the remaining current component accumulated in the first thin film transistor TFT1 and the photodiode 37, thereby improving actual sensitivity and signal to noise ratio. To this end, a source of the second thin film transistor TFT2 is commonly connected to the photodiode 37 and a gate of the third thin film transistor TFT3, and a drain of the second thin film transistor TFT2 is connected to a VDD line. In addition, a gate of the second thin film transistor TFT2 may be connected to a gate reset line.

In addition, the third thin film transistor TFT3 serves to amplify a brightness signal output from the photodiode 37 and to send the amplified signal to the first thin film transistor TFT1. To this end, a source of the third thin film transistor TFT3 may be commonly connected to the VDD line and a drain of the first thin film transistor TFT1, and a drain of the third thin film transistor TFT3 may be connected to the source of the first thin film transistor TFT1. In addition, a gate of the third thin film transistor TFT3 may be commonly connected to the photodiode 37 and the source of the second thin film transistor TFT2.

The photo-sensor unit 120 including three thin film transistors may include a substrate 21, a first gate 23a, a second gate 23b, a third gate 23c, a first insulation layer 25, a first semiconductor active layer 27a, a second semiconductor active layer 27b, a third semiconductor active layer 27c, a drain 29, a first connection electrode, a second connection electrode, a source 31, a second insulation layer 33, a lower electrode 35, the photodiode 37, a transparent electrode 39, a third insulation layer 41, a data line 43, a bias line 45, and a protective layer 47.

Each of the first gate 23a, the second gate 23b and the third gate 23c is disposed on the substrate 21 to have a predetermined length. In addition, each of the first gate 23a, the second gate 23b and the third gate 23c may have a protrusion protruding therefrom in the perpendicular direction with respect to the longitudinal direction thereof.

The first insulation layer 25 may be disposed so as to cover upper surfaces of the first gate 23a, the second gate 23b and the third gate 23c, and the first gate 23a, the second gate 23b and the third gate 23c may be insulated from one another by the first insulation layer 25.

The first semiconductor active layer 27a, the second semiconductor active layer 27b and the third semiconductor active layer 27c may be disposed on the first insulation layer 25 to be disposed above the first gate 23a, the second gate 23b and the third gate 23c, respectively.

The drain 29, the first connection electrode 30a, the second connection electrode 30b and the source 31 may be disposed to cover portions of the first semiconductor active layer 27a, the second semiconductor active layer 27b and the third semiconductor active layer 27c. The drain 29 is disposed to cover a portion of the first semiconductor active layer 27a, and the first connection electrode 30a is disposed to cover a portion of each of the first semiconductor active layer 27a and the third semiconductor active layer 27c. The second connection electrode 30b is electrically connected to the third gate 23c through a first via-hole H1 formed in the first insulation layer 25, and covers a portion of the second semiconductor active layer 27b. The source 31 is disposed to cover a portion of each of the second semiconductor active layer 27b and the third semiconductor active layer 27c. The source 31 may be connected to the VDD line.

The second insulation layer 33 is disposed to cover the drain 29, the first connection electrode 30a, the second connection electrode 30b and the source 31.

The lower electrode 35 is disposed on the second insulation layer 33, and may be electrically connected to the second connection electrode through a second via-hole H2 formed in the second insulation layer 33. The lower electrode 35 may be formed of a single metal or an alloy including at least one of Al, Al—Nd, Al—Cu, Mo, Ti, Ta and Cr, and may be composed of a single layer or multiple layers.

The photodiode 37 may be disposed on the lower electrode 35 and the transparent electrode 39 may be disposed on the photodiode 37.

The third insulation layer 41 may be disposed on the transparent electrode 39 and may have a sufficient size to cover the entirety of the substrate 21.

The data line 43 and the bias line 45 may be disposed on the third insulation layer 41. The data line 43 may be electrically connected to the drain 29 through a third via-hole H3 formed in the second insulation layer 33 and the third insulation layer 41. The bias line 45 may be electrically connected to the transparent electrode 39 through a fourth via-hole formed in the third insulation layer 41.

The protective layer 47 may be disposed to cover the data line 43 and the bias line 45.

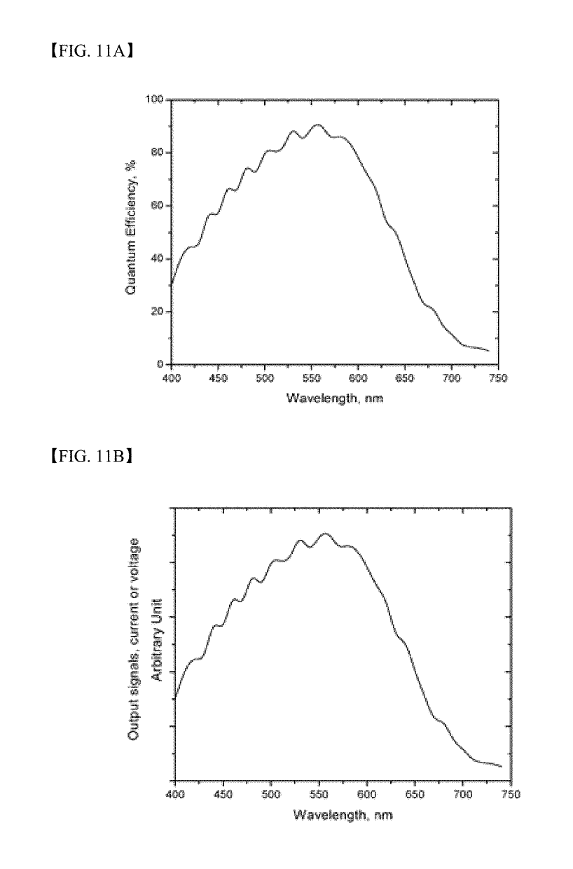

FIG. 11A and FIG. 11B are graphs depicting quantum efficiency and output signals of the photodiode of the optical biosensor according to the exemplary embodiment of the present disclosure.

In one example, in order to confirm quantum efficiency and output signals of the photodiode 37, the photodiode 37 was irradiated with light until the photodiode 37 reaches complete saturation. A light source including a combination of a red LED, a green LED and a blue LED was used and light in a wavelength band of 200 nm to 750 nm was emitted from the light source to the photodiode 37.

The photodiode 37 formed of amorphous silicon exhibited quantum efficiency according to wavelength as shown in FIG. 11A. In addition, a thin film transistor acting as a read-out element of the photodiode 37 outputs a current or voltage signal by the photoelectric effect of the photodiode 37 based on the quantum efficiency as shown in FIG. 11A. FIG. 11B shows the output signals of the photodiode 37.

When visible light enters the photodiode 37 until the photodiode 37 reaches constant and complete saturation, the output from the photodiode 37 may correspond to an integral value of the quantum efficiency of the photodiode 37 according to wavelength.

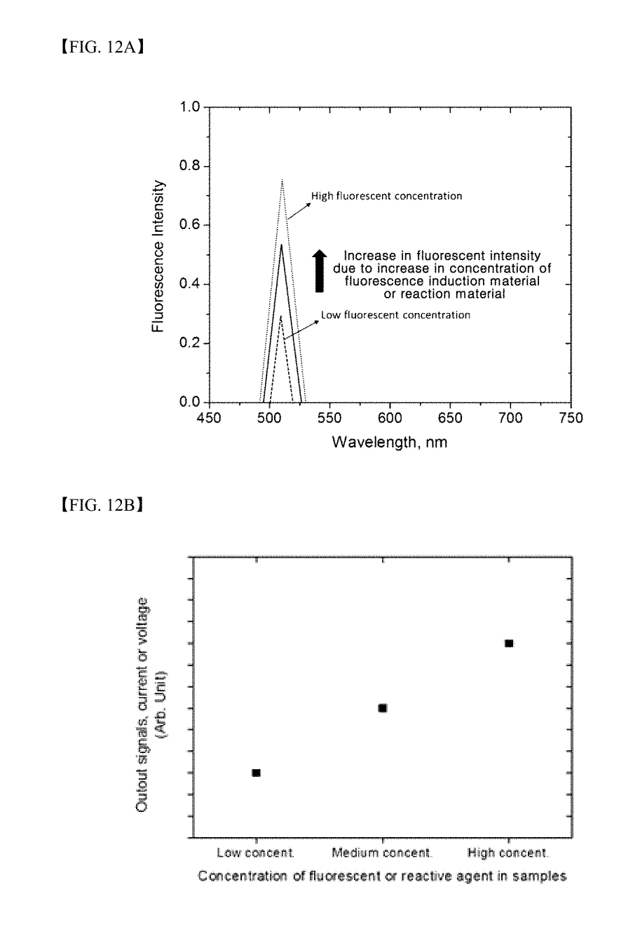

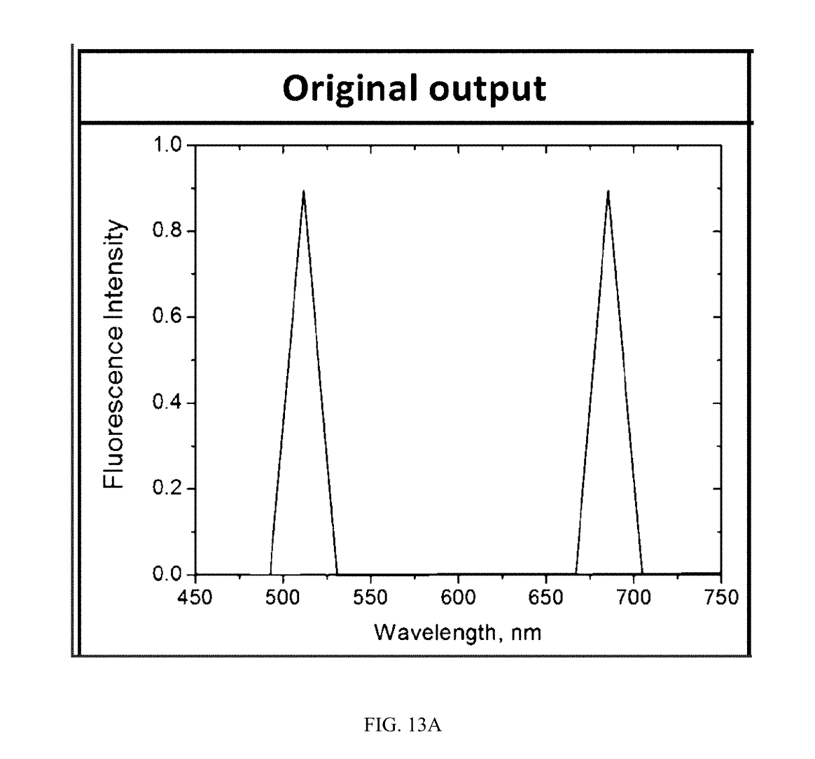

FIG. 12A and FIG. 12B are a graph depicting increase in fluorescence intensity through reaction of the fluorescence induction material in the fluorescent bio-sample layer of the optical biosensor according to the exemplary embodiments of the present disclosure and a graph depicting an electrical signal output, respectively.

As shown in FIG. 12A, the fluorescence intensity of the optical biosensor 100 according to the exemplary embodiments increases with increasing concentration of the fluorescence induction material or a reaction material in the fluorescent bio-sample layer 135 of the optical biosensor 100.

Conventionally, even when the concentration of the fluorescence induction material increases, a result value can be obtained through a process of photographing the corresponding fluorescent intensity using a detector, such as a CCD camera, and converting the photographed image into an electrical signal. Conversely, in the optical biosensor 100 according to the exemplary embodiments, the fluorescent intensity as shown in FIG. 12A can be detected by the photo-sensor unit and can be converted into an electrical signal by the thin film transistor or the TFT, which in turn outputs the electrical signal as shown in FIG. 12B, thereby eliminating an additional process.

Advantageously, the optical biosensor 100 according to the exemplary embodiments can provide the results as shown in FIG. 12A and FIG. 12B at the same time.

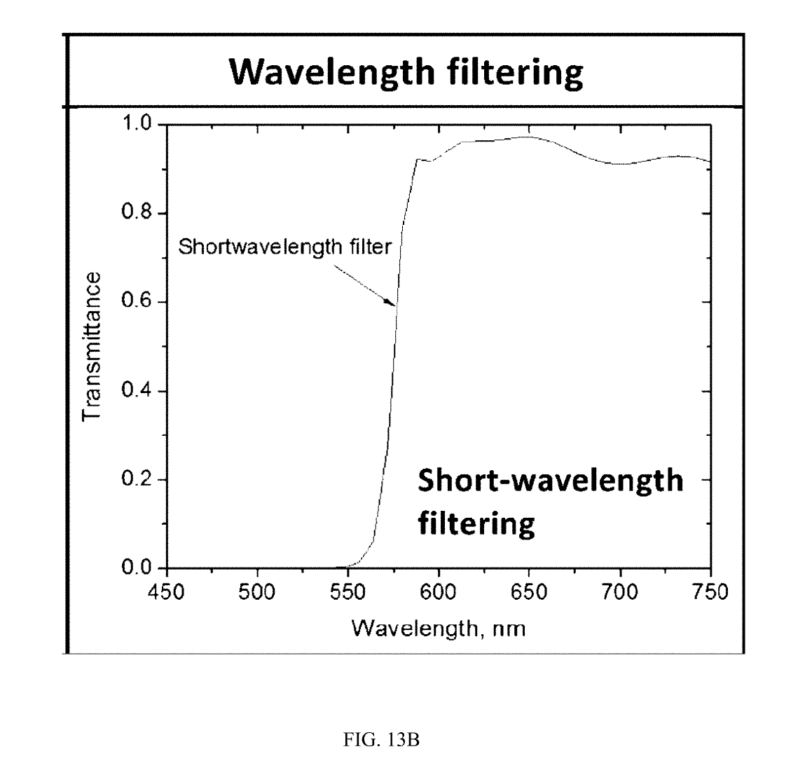

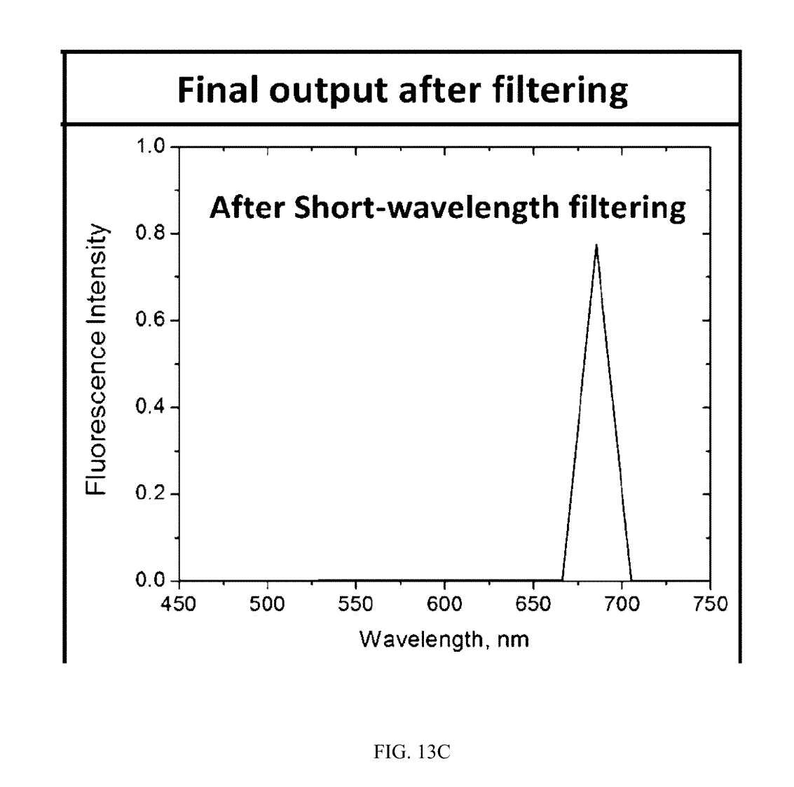

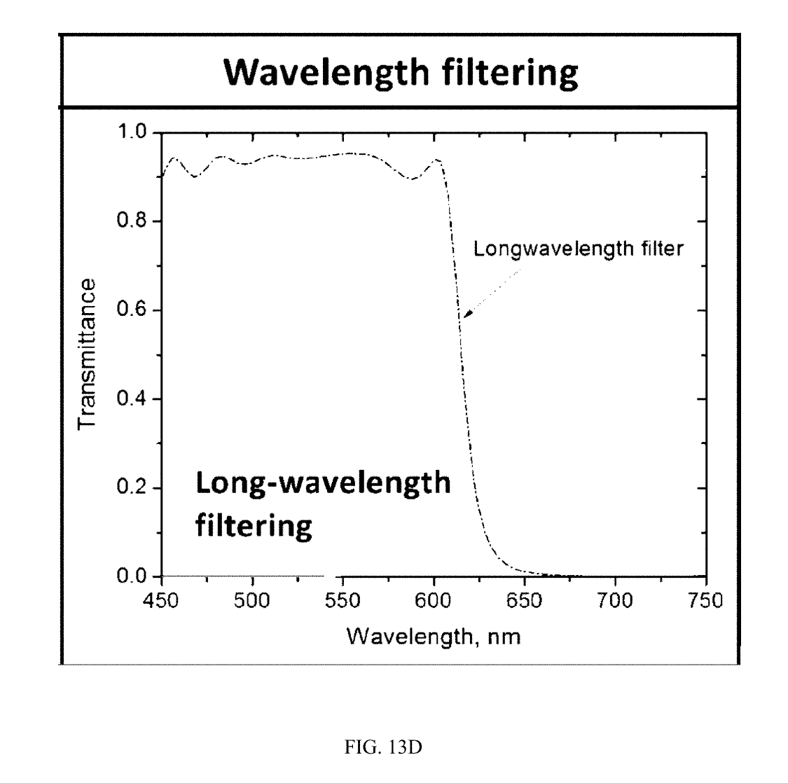

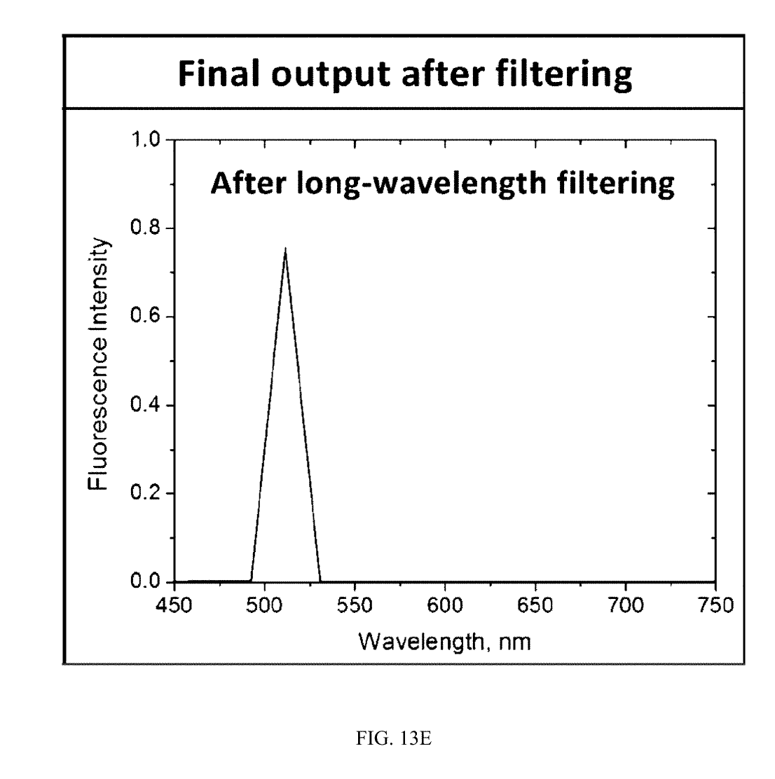

FIG. 13A to FIG. 13E are graphs depicting a function of the wavelength filter of the optical biosensor according to the exemplary embodiments of the present disclosure.

The function of the wavelength filter 125 will be described with reference to FIG. 13A to FIG. 13E. Here, it should be noted that, in the graphs of FIG. 13A to FIG. 13E, the ordinate indicates relative values instead of absolute values and the abscissa indicates exemplary peak wavelength values.

Specifically, when light having a peak wavelength as shown in FIG. 13A is emitted to a short wavelength filter as shown in FIG. 13B, only a fraction of the light in a high peak wavelength band as shown in FIG. 13C can pass through the short wavelength filter. In addition, when light having a peak wavelength as shown in FIG. 13A is emitted to a long wavelength filter as shown in FIG. 13D, only a fraction of the light in a low peak wavelength band as shown in FIG. 13E can pass through the long wavelength filter.

By way of example, upon fluorescence resonance energy transfer (FRET) assay of DNA or biochemical substances, a fluorescent or luminous transition having at least one wavelength can occur. Since the photo-sensor of the optical biosensor 100 according to this exemplary embodiment converts the intensity of light into an electrical signal, the wavelength filter 125 is disposed on the photo-sensor in order to perform selective assay in a particular wavelength band.

Although the optical biosensor according to the exemplary embodiments includes the wavelength filter 125, the wavelength filter 125 can be omitted as needed.

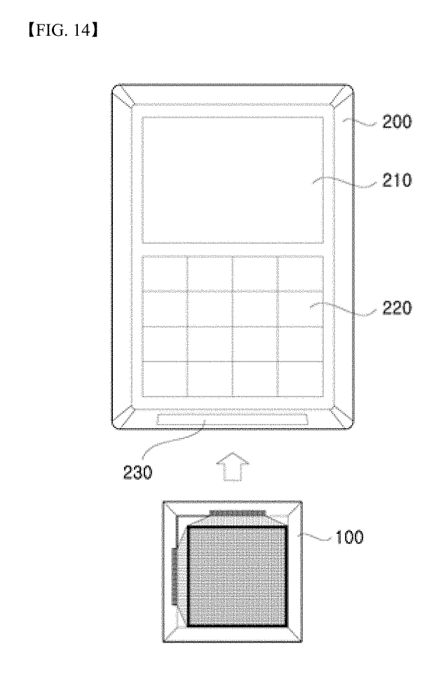

FIG. 14 shows the optical biosensor according to the exemplary embodiments of the present disclosure and an analyzer.

Referring to FIG. 14, the optical biosensor 100 according to the exemplary embodiment may be inserted into an insert hole of an analyzer. When power is supplied to the optical biosensor 100 inserted into the analyzer through the insert hole, light is emitted to the optical biosensor 100 and then a bio-sample is reacted to display a reaction result on a display part of the analyzer. An input unit may be disposed under the display part such that a user can input information for analysis through the input unit.

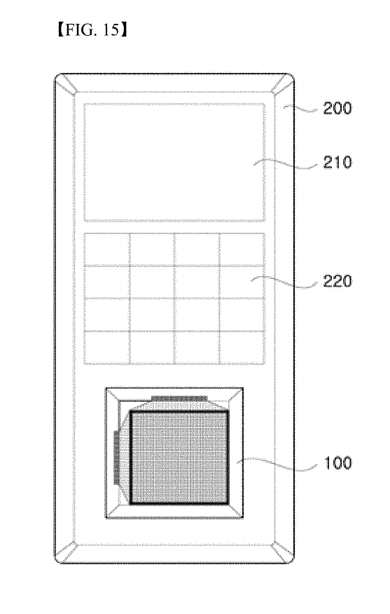

FIG. 15 shows the optical biosensor according to the exemplary embodiments of the present disclosure and a modification of the analyzer.

Referring to FIG. 15, the analyzer according to the modification is configured to allow the optical biosensor 100 to be mounted on a lower side of the display part. Other components of the analyzer are the same as those of the analyzer according to the above embodiment, and the optical biosensor 100 may be mounted under the input unit of the analyzer. The analyzer shown in FIG. 15 may be configured to allow a light source to be disposed below the optical biosensor 100.

Although certain exemplary embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

### LIST OF REFERENCE NUMERALS

100: optical biosensor

| | |
|---|---|
| 110: mount | 120: photo-sensor unit |

122: sub-cell

| | |
|---|---|
| 21: substrate | 23a: first gate |
| 23b: second gate | 23c: third gate |
| 25: first insulation layer | 27a: first semiconductor |
| | active layer |
| 27b: second semiconductor | 27c: third semiconductor |
| active layer | active layer |

28: ohmic contact layer

| | |
|---|---|
| 29: drain | 30: connection electrode |
| 30a: first connection electrode | 30b: second connection electrode |
| 31: source | 33: second insulation layer |
| 35: lower electrode | 37: photodiode |
| 37a: n-type semiconductor layer | 37b: intrinsic semiconductor layer |

37c: p-type semiconductor layer

| | |
|---|---|
| 39: transparent electrode | 41: third insulation layer |
| 43: data line | 44: light blocking layer |
| 45: bias line | 47: protective layer |

H1~H3: first to third via-holes
TFT1~TFT3: first to third thin film transistors

| | |
|---|---|
| 125: wavelength filter | 135: a fluorescent bio-sample layer |
| 140: wall | 145: excitation filter |
| 160: read-out pad | 170: gate driving pad |
| SA: assay sensing area | RA: reference sensing area |

What is claimed is:

1. An optical biosensor comprising:
a substrate;
a photo-sensor disposed on the substrate and generating an electrical signal upon irradiation with light; and
a bio-sample layer disposed on the photo-sensor and containing a target substance to be assayed and an induction material emitting light through fluorescence, extinction or luminescence upon irradiation with light,
wherein the photo-sensor is irradiated with light emitted from the induction material through fluorescence, extinction or luminescence.

2. The optical biosensor according to claim 1, further comprising:
a light source irradiates light to the photo-sensor; and
a wavelength filter interposed between the photo-sensor and the bio-sample layer and blocking a fraction of light emitted from the bio-sample layer and the light source to the photo-sensor.

3. The optical biosensor according to claim 2, wherein the wavelength filter is detached from or coupled between the photo-sensor and the bio-sample layer depending upon an irradiation location of the photo-sensor with light.

4. The optical biosensor according to claim 2, wherein the photo-sensor comprises a plurality of sub-cells;
the wavelength filter comprises at least one of a short wavelength filter blocking light in a relatively short wavelength band, a middle wavelength filter blocking light in a relatively medium wavelength band, and a long wavelength filter blocking light in a relatively long wavelength band; and
at least one of the short wavelength filter, the medium wavelength filter and the long wavelength filter is provided to each of the sub-cells.

5. The optical biosensor according to claim 2, wherein the wavelength filter is a thin film or a thick film comprising at least one of indium (In), tin (Sn), gallium (Ga), zinc (Zn) and oxygen (O).

6. The optical biosensor according to claim 1, further comprising:
a light source irradiates light to the photo-sensor; and
a wavelength filter blocking a fraction of light emitted from the bio-sample layer and the light source to the photo-sensor,
wherein the wavelength filter is disposed on the photo-sensor unit or the bio-sample layer.

7. The optical biosensor according to claim 1, wherein the bio-sample layer is disposed on a portion of the photo-sensor to form an assay sensing area and a remaining portion of the photo-sensor with no bio-sample layer disposed thereon forms a reference sensing area.

8. The optical biosensor according to claim 1, wherein the photo-sensor comprises:
a photodiode generating an electrical signal upon irradiation with light; and
a first thin film transistor processing the electrical signal generated by the photodiode.

9. The optical biosensor according to claim 8, wherein the photo-sensor further comprises:
a second thin film transistor removing a remaining current component accumulated in the photodiode and the first thin film transistor.

10. The optical biosensor according to claim 9, further comprising:
a gate line; a gate reset line; and a data line,
wherein each of the first and second thin film transistors is disposed in a region in which the gate line, the gate reset line and the data line are formed.

11. The optical biosensor according to claim 10, wherein the first thin film transistor comprises a gate, a source, and a drain,
the drain of the first thin film transistor is connected to the data line, and
the gate of the first thin film transistor is connected to the gate line.

12. The optical biosensor according to claim 11, wherein the second thin film transistor comprises a gate, a source, and a drain, and the gate of the second thin film transistor is connected to the gate reset line.

13. The optical biosensor according to claim 9, further comprising:
a third thin film transistor amplifying an output from the photodiode.

14. The optical biosensor according to claim 13, further comprising:
a gate line; a gate reset line; and a data line,
wherein the third thin film transistor is disposed in a region in which the gate line, the gate reset line and the data line are formed.

15. The optical biosensor according to claim 1, wherein the photo-sensor comprises a complementary metal oxide semiconductor (CMOS) in which a photodiode generating an electrical signal upon irradiation with light and a MOSFET are combined.
